(19) United States
(12) Patent Application Publication
(10) Pub. No.: US 2023/0057967 A1
(43) Pub. Date: Feb. 23, 2023

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yuta TONE, Nagoya-shi (JP); Yukinori II, Toyota-shi (JP); Tadayuki TANAKA, Nagoya-shi (JP); Naoki ISHIZUKA, Nagoya-shi (JP); Yuichiro YANO, Nagakute-shi (JP); Nariaki AMANO, Nagoya-shi (JP); Yusuke MAEDA, Miyoshi-shi (JP); Kei YAZAKI, Okazaki-shi (JP); Yu HAMADA, Nagoya-shi (JP)

(73) Assignee: TOYOTA JIDOSHA KABUSHIKI KAISHA, Toyota-shi (JP)

(21) Appl. No.: 17/889,869

(22) Filed: Aug. 17, 2022

(30) Foreign Application Priority Data
Aug. 17, 2021 (JP) 2021-132947

(51) Int. Cl. G06Q 10/00

(52) U.S. Cl. CPC G06Q 10/20

(57) ABSTRACT

An information processing apparatus acquires second information and third information based on first information for identifying a specific vehicle. The second information is information about a vehicle part that is attachable to the specific vehicle. The third information is information about a vehicle part that is currently attached to the specific vehicle. The information processing apparatus identifies a specific part that is a vehicle part that is to be proposed to be attached to the specific vehicle, based on the second information and the third information. The information processing apparatus transmits information about the specific part to a terminal associated with a user of the specific vehicle.

### CROSS REFERENCE TO THE RELATED APPLICATION

This application claims the benefit of Japanese Patent Application No. 2021-132947, filed on Aug. 17, 2021, which is hereby incorporated by reference herein in its entirety.

### BACKGROUND

### Technical Field

The present disclosure relates to an information processing apparatus, an information processing method, and a non-transitory storage medium.

### Description of the Related Art

Patent Literature 1 discloses a vehicle maintenance system. The vehicle maintenance system disclosed in Patent Literature 1 includes a server and a user terminal. The server receives information about a reservation number and a vehicle to be maintained from the user terminal, and displays the information about the vehicle to be maintained. Furthermore, the server transmits the state of progress of maintenance of the vehicle to the user terminal. Moreover, in the case where the reservation number that is received and a reservation number that is input by the user match, the server identifies the user as the user to whom the maintained vehicle is to be handed over.
[Patent Literature 1] Japanese Patent Laid-Open No 2006-11577

### SUMMARY

An object of the present disclosure is to appropriately inform a user who is thinking about attaching a vehicle part to a vehicle, about attachment of the vehicle part.

An information processing apparatus according to a first aspect of the present disclosure includes a controller comprising at least one processor, the controller being configured to:

acquire, based on first information for identifying a specific vehicle, second information about a vehicle part that is attachable to the specific vehicle, and third information about a vehicle part that is currently attached to the specific vehicle,

identify, based on the second information and the third information, a specific part that is a vehicle part that is to be proposed to be attached to the specific vehicle, and

transmit information about the specific part to a terminal associated with a user of the specific vehicle.

An information processing method according to a second aspect of the present disclosure is

an information processing method performed by a computer, the information processing method including:

acquiring, based on first information for identifying a specific vehicle, second information about a vehicle part that is attachable to the specific vehicle, and third information about a vehicle part that is currently attached to the specific vehicle;

identifying, based on the second information and the third information, a specific part that is a vehicle part that is to be proposed to be attached to the specific vehicle; and

transmitting information about the specific part to a terminal associated with a user of the specific vehicle.

A non-transitory storage medium according to a third aspect of the present disclosure is

a non-transitory storage medium storing a program for causing a computer to execute an information processing method, where the information processing method includes:

acquiring, based on first information for identifying a specific vehicle, second information about a vehicle part that is attachable to the specific vehicle, and third information about a vehicle part that is currently attached to the specific vehicle,

identifying, based on the second information and the third information, a specific part that is a vehicle part that is to be proposed to be attached to the specific vehicle, and

transmitting information about the specific part to a terminal associated with a user of the specific vehicle.

According to the present disclosure, a user who is thinking about attaching a vehicle part to a vehicle may be appropriately informed about attachment of the vehicle part.

### BRIEF DESCRIPTION OF THE DRAWINGS

FIG. 1 is a diagram illustrating a schematic configuration of a proposal system;

FIG. 2 is a block diagram schematically illustrating an example of a functional configuration of a proposal server;

FIG. 3 is a diagram illustrating an example of a table structure of vehicle information;

FIG. 4 is a diagram illustrating an example of a table structure of attachable part information stored in an attachable part information database;

FIG. 5 is a diagram illustrating an example of a table structure of attached part information stored in an attached part information database;

FIG. 6 is a flowchart of a proposal process according to a first embodiment;

FIG. 7 is a flowchart of a proposal process according to a second embodiment; and

FIG. 8 is a flowchart of a proposal process according to a third embodiment.

### DESCRIPTION OF THE EMBODIMENTS

A case is assumed where a user of a specific vehicle wants a vehicle part to be attached to the specific vehicle. In this case, a vehicle part that is attachable may be different for each vehicle. Furthermore, there is no need for the user to have a vehicle part that is already attached to the specific vehicle attached again. Accordingly, the user has to know the vehicle part that is attachable to the specific vehicle and that is not a vehicle part that is currently attached to the specific vehicle. It may thus be difficult for the user to know which vehicle part to attach, at the time of attaching a vehicle part to the specific vehicle.

An information processing apparatus according to a first mode of the present disclosure is an apparatus that manages attachment of a vehicle part to a vehicle. A controller, comprising at least one processor, of the information processing apparatus according to the first mode of the present disclosure is capable of grasping the vehicle part that is attachable to a specific vehicle, by identifying the specific vehicle. Furthermore, the controller of the information processing apparatus is capable of grasping the vehicle part that is currently attached to the specific vehicle, by identifying the specific vehicle. To this end, the controller acquires second information and third information based on first information for identifying the specific vehicle. The second information here is information about a vehicle part that is attachable to the specific vehicle. The third information is information about a vehicle part that is currently attached to the specific vehicle. The controller identifies, based on the second information and the third information, a specific part that is a vehicle part that is to be proposed to be attached to the specific vehicle. Furthermore, the controller transmits information about the specific part to a terminal associated with a user of the specific vehicle.

As described above, the information processing apparatus identifies the specific part based on the second information and the third information acquired based on the first information. Then, the information processing apparatus transmits information about the specific part to the terminal associated with the user of the specific vehicle. An appropriate proposal regarding attachment of a vehicle part may thus be made to a user considering attachment of a vehicle part to a vehicle.

Hereinafter, specific embodiments of the present disclosure will be described with reference to the drawings. Dimensions, materials, shapes, relative positions and the like of structural components described in the present embodiments are not intended to limit the technical scope of the present disclosure unless stated otherwise.

### First Embodiment

(Outline of System)

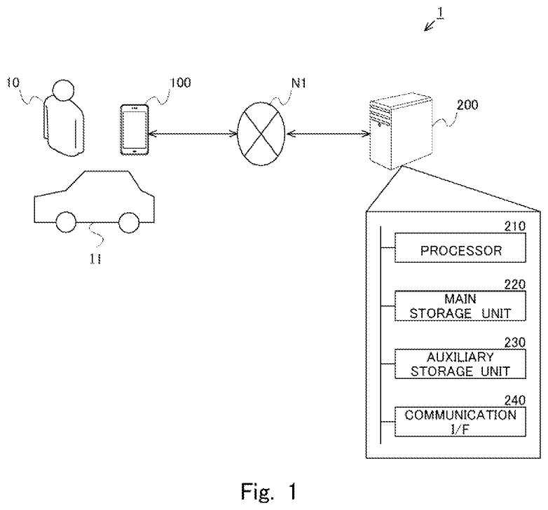

A proposal system 1 according to a present embodiment will be described with reference to FIG. 1. FIG. 1 is a diagram illustrating a schematic configuration of the proposal system 1. The proposal system 1 includes a user terminal 100 and a proposal server 200. In the proposal system 1, the user terminal 100 and the proposal server 200 are connected to each other through a network N1. The network N1 is a wide area network (WAN), which is a worldwide public communication network such as the Internet, or a mobile communication network for mobile phones, for example.

(User Terminal)

The user terminal 100 is a terminal that is associated with a user 10. The user terminal 100 is a computer, a personal digital assistant or the like that is used by the user 10. The user 10 is a user who uses a user vehicle 11. The user 10 may wish to attach a vehicle part to the user vehicle 11. At this time, the user 10 places an order for attachment of the vehicle part to the user vehicle 11, to a manufacturer or a dealer of the user vehicle 11 by using the user terminal 100.

The vehicle part that is attached to the user vehicle 11 when the user 10 places an order for attachment of a vehicle part is a part that is to be newly attached to the user vehicle 11. The vehicle part to be attached to the user vehicle 11 may be a new vehicle part that is attached by removing an old vehicle part that is already attached to the user vehicle 11. For example, the vehicle part to be attached to the user vehicle 11 is a door a steering wheel, or a seat of the user vehicle 11, a car navigation system, or the like. For example, in the case where the door of the user vehicle 11 is a manual door, the user 10 may want to newly attach an electric door. Furthermore, for example, the user 10 may want to replace a seat of the user vehicle 11 that is currently attached. Furthermore, for example, the user 10 may want to change the steering wheel that is currently attached to a different steering wheel. Furthermore, the user 10 may want to newly install a car navigation system on the user vehicle 11 where a car navigation system is not installed. Furthermore, replacement of the car navigation system may be desired in relation to the user vehicle 11 where a car navigation system is installed.

At this time, the vehicle part that is attachable may be different depending on the vehicle. Furthermore, there is no need for the user 10 to newly attach a vehicle part that is the same as a vehicle part that is already attached to the user vehicle 11. Accordingly, the user 10 has to know the vehicle part that is attachable to the user vehicle 11 and that is not a vehicle part that is currently attached to the user vehicle 11. It is thus possibly difficult for the user 10 to know which vehicle part to attach, at the time of attaching a vehicle part to the user vehicle 11. Accordingly, before placing an order for attachment of a vehicle part to the user vehicle 11, the user 10 receives, using the user terminal 100, information about a vehicle part that is proposed to be attached to the user vehicle 11 (hereinafter, such a part will be sometimes referred to as “specific part”), from the proposal server 200.

(Proposal Server)

The proposal server 200 is a server that makes a proposal regarding the specific part to the user 10. Details of a method used by the proposal server 200 to make a proposal regarding the specific part to the user 10 will be given later.

The proposal server 200 includes a computer including a processor 210, a main storage unit 220, an auxiliary storage unit 230, and a communication interface (communication I/F) 240. The processor 210 is a central processing unit (CPU) or a digital signal processor (DSP), for example. The main storage unit 220 is a random access memory (RAM), for example. The auxiliary storage unit 230 is a read only memory (ROM), for example. Furthermore, the auxiliary storage unit 230 is a hard disk drive (HDD), or a disk recording medium such as a CD-ROM, a DVD disc or a Blu-ray disc, for example. The auxiliary storage unit 230 may also be a removable medium (a removable storage medium). Here, as the removable medium, a USB memory or an SD card may be cited as an example. The communication I/F 240 is a local area network (LAN) interface board, or a wireless communication circuit for wireless communication, for example.

An operating system (OS), various programs, various information tables and the like are stored in the auxiliary storage unit 230 in the proposal server 200. Furthermore, with the proposal server 200, various functions as described later may be implemented by the processor 210 loading, in the main storage unit 220, and executing the programs stored in the auxiliary storage unit 230. However, some or all of the functions of the proposal server 200 may alternatively be implemented by a hardware circuit such as an ASIC or an FPGA. Additionally, the proposal server 200 does not have to be implemented by a single physical configuration, but may alternatively be a plurality of computers operating in conjunction with each other.

(Functional Configuration)

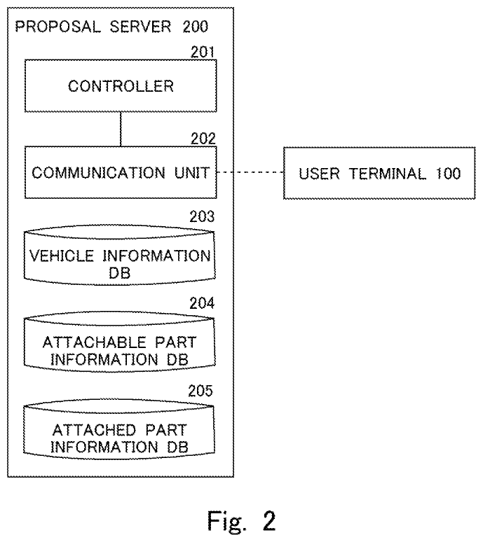

Next, a functional configuration of the proposal server 200 in the proposal system 1 according to the present embodiment will be described with reference to FIGS. 2 to 5. FIG. 2 is a block diagram schematically illustrating an example of the functional configuration of the proposal server 200.

The proposal server 200 includes a controller 201, a communication unit 202, a vehicle information database 203 (a vehicle information DB 203), an attachable part information database 204 (an attachable part information DB 204), and an attached part information database 205 (an attached part information DB 205). The controller 201 includes a function of performing arithmetic processing to control the proposal server 200. The controller 201 may be implemented by the processor 210 in the proposal server 200. The communication unit 202 includes a function of connecting the proposal server 200 to the network N1. The communication unit 202 may be implemented by the communication I/F 240 in the proposal server 200.

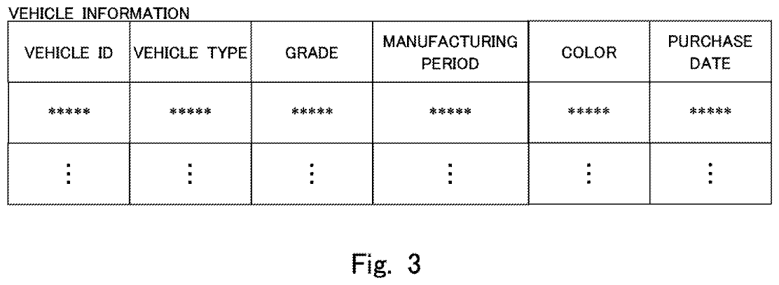

The vehicle information DB 203 is a database for storing vehicle information. The vehicle information is information for identifying a vehicle type and the like of a vehicle. The vehicle information DB 203 may be implemented by the auxiliary storage unit 230 in the proposal server 200. For example, the vehicle information is created when a dealer or the like selling the user vehicle 11 transmits, at a time of selling the user vehicle 11, information about the user vehicle 11 to the proposal server 200. FIG. 3 is a diagram illustrating an example of a table structure of the vehicle information. As illustrated in FIG. 3, the vehicle information includes a vehicle ID field, a vehicle type field, a grade field, a manufacturing period field, a color field, and a purchase date field.

An identifier (a vehicle ID) for identifying a vehicle is input in the vehicle ID field. In the present embodiment, a frame number of the vehicle is input in the vehicle ID field. Additionally, the vehicle ID that is input in the vehicle ID field may alternatively be a vehicle identification number (a VIN code). A vehicle type of the vehicle corresponding to the vehicle ID input in the vehicle ID field is input in the vehicle type field. Here, the vehicle type of a vehicle that is input in the vehicle type field is a vehicle type (a vehicle name) set by the manufacturer of the vehicle. A grade of the vehicle corresponding to the vehicle ID input in the vehicle ID field is input in the grade field. A manufacturing period of the vehicle corresponding to the vehicle ID input in the vehicle ID field is input in the manufacturing period field. A color of the vehicle corresponding to the vehicle ID input in the vehicle ID field is input in the color field. A purchase date/time of the vehicle corresponding to the vehicle ID input in the vehicle ID field is input in the purchase date field. The date of purchase of the user vehicle 11 by the user 10 is input in the purchase date field.

The controller 201 receives, from the user terminal 100, information for identifying the user vehicle 11 (hereinafter sometimes referred to as “user information”), by using the communication unit 202. The user information is information including the vehicle ID (the frame number of the user vehicle 11) of the user vehicle 11. The controller 201 identifies the vehicle type, the grade, the manufacturing period, the color, and the purchase date of the user vehicle 11, based on the user information received from the user terminal 100.

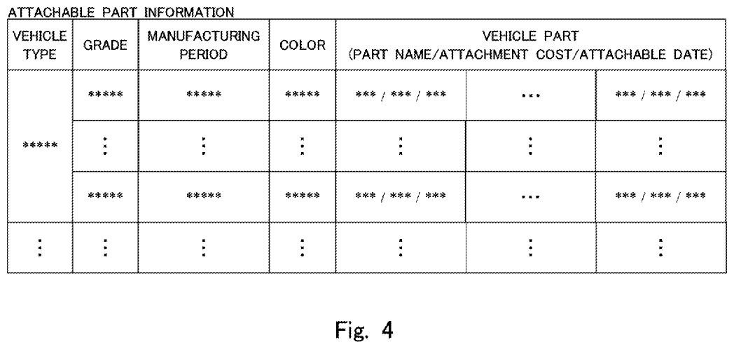

The attachable part information DB 204 is a database for storing attachable part information. The attachable part information is information about a vehicle part that is attachable to a vehicle. The information about a vehicle part that is attachable to a vehicle is classified based on the vehicle type, the grade, the manufacturing period, and the color of a vehicle. The attachable part information DB 204 may be implemented by the auxiliary storage unit 230 in the proposal server 200. FIG. 4 is a diagram illustrating an example of a table structure of the attachable part information stored in the attachable part information DB 204. As illustrated in FIG. 4, the attachable part information includes a vehicle type field, a manufacturing period field, a grade field, a color field, and a vehicle part field.

A vehicle type (a vehicle name) set by the manufacturer of a vehicle is input in the vehicle type field. Here, vehicles of a same vehicle type may be designed differently depending on the manufacturing period. Even when vehicles are of a same vehicle type, attachable parts may be different depending on the manufacturing period. Accordingly, a period when the vehicle type input in the vehicle type field is manufactured with the same design is input in the manufacturing period field.

Furthermore, even when vehicles are of the same vehicle type, the designs of the vehicles may be different depending on the grades of the vehicles. Accordingly, even when vehicles are of the same vehicle type, attachable parts may be different depending on the grades of the vehicles. Accordingly, the grade of the vehicle type input in the vehicle type field is input in the grade field.

Furthermore, even when vehicles are of the same vehicle type, attachable parts are expected to be different depending on the colors of the vehicles. For example, a case is conceivable where a vehicle part corresponding to the color of a vehicle is out of stock and the part cannot be attached. Accordingly, the color of a vehicle that can be selected in relation to the vehicle type input in the vehicle type field is input in color field.

Information about a vehicle part is input in the vehicle part field. More specifically, a part name of a vehicle part that is attachable to a vehicle corresponding to each vehicle type, each manufacturing period, each grade, and each color is input in the vehicle part field. Here, the part name of a vehicle part is a model number, a model name or the like of the vehicle part. Furthermore, a cost (an attachment cost) for attaching a vehicle part that is attachable to a vehicle corresponding to each vehicle type, each manufacturing period, each grade, and each color is input in the vehicle part field. Moreover, a date (an attachable date) when attachment of a vehicle part that is attachable to a vehicle corresponding to each vehicle type, each manufacturing period, each grade, and each color becomes possible is input in the vehicle part field.

The controller 201 acquires information (the attachable part information corresponding to the user vehicle 11) about the vehicle part corresponding to the vehicle type, the grade, the manufacturing period, and the color matching the vehicle type, the grade, the manufacturing period, and the color of the user vehicle 11 identified based on the user information. By acquiring the attachable part information corresponding to the user vehicle 11, the controller 201 may grasp the vehicle part that is attachable to the user vehicle 11, the cost for attaching the vehicle part, and the attachable date of the vehicle part.

Here, a case is conceivable where a vehicle part is attachable to the vehicle but the vehicle part is out of stock. In this case, information about such a vehicle part is not input in the vehicle part field. Moreover, even when information about the same vehicle part is input in the vehicle part field, the number of steps for attachment is possibly different depending on the vehicle type, the manufacturing period, the grade, and the color of the vehicle. Accordingly, when the same vehicle part is attachable to two vehicles differing in at least one of the vehicle type, the manufacturing period, the grade, and the color, different attachment costs may be input in the vehicle part field.

Additionally, in the present embodiment, the attachable part information includes the vehicle type field, the manufacturing period field, the grade field, the color field, and the vehicle part field. However, the attachable part information does not necessarily have to include the vehicle type field, the manufacturing period field, the grade field, the color field, and the vehicle part field. The attachable part information may be information that includes at least the vehicle type field and the vehicle part field. In this case, the proposal server 200 acquires the attachable part information corresponding to the user vehicle 11 based on the vehicle type of the user vehicle 11.

The attached part information DB 205 is a database for storing attached part information. The attached part information DB 205 may be implemented by the auxiliary storage unit 230 in the proposal server 200. The attached part information is information about a vehicle part that is currently attached to the vehicle. The attached part information is created by a person who attached a vehicle part (attaching person) transmitting, to the proposal server 200, information about the vehicle ID of the vehicle to which the vehicle part was attached, the vehicle part that was attached, and the attaching person (hereinafter sometimes referred to as “attachment information”). The attaching person here is the manufacturer, the dealer, or the user of the vehicle, for example.

For example, a manufacturer of a vehicle transmits the attachment information to the proposal server 200 at the time of the manufacturer attaching a vehicle part at the time of manufacture of the vehicle. Furthermore, for example, a dealer of a vehicle transmits the attachment information to the proposal server 200 at the time of the dealer attaching a vehicle part before delivering the vehicle. A user of a vehicle transmits the attachment information to the proposal server 200 at the time of the user attaching a vehicle part himself/herself. Furthermore, the attachment information may be transmitted from a maintenance agency to the proposal server 200 at the time of maintenance of the user vehicle 11, by the maintenance agency checking the parts attached to the vehicle of the user. For example, in the case where an irregular vehicle part is attached to the vehicle of the user, the maintenance agency identifies the user as the attaching person of the vehicle part. Furthermore, for example, in the case where a vehicle part that is a regular product is attached to the vehicle of the user, the maintenance agency identifies the manufacturer or the dealer as the attaching person of the vehicle part.

Additionally, in the present embodiment, an attaching person other than the manufacturer and the dealer is assumed to be the user. However, the attaching person other than the manufacturer and the dealer may be a vehicle workshop, other than a vehicle workshop of the manufacturer or the dealer, where attachment of a vehicle part may be carried out. In this case, staff or the like of the vehicle workshop may transmit the attachment information to the proposal server 200.

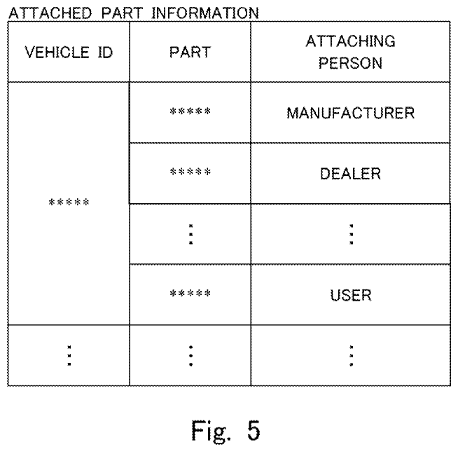

FIG. 5 is a diagram illustrating an example of a table structure of the attached part information stored in the attached part information DB 205. As illustrated in FIG. 5, the attached part information includes a vehicle ID field, a part field, and an attaching person field. The vehicle ID is input in the vehicle ID field. A vehicle part that is currently attached to the vehicle corresponding to the vehicle ID input in the vehicle ID field is input in the part field. The attaching person of the vehicle part input in the part field is input in the attaching person field.

The controller 201 acquires the attached part information about the user vehicle 11 from the attached part information DB 205, based on the user information. By acquiring the attached part information about the user vehicle 11 from the attached part information DB 205, the controller 201 may grasp the vehicle part that was attached to the user vehicle 11 by the manufacturer, the dealer, or the user 10. That is, the controller 201 may grasp the vehicle part that is currently attached to the user vehicle 11, by acquiring the attached part information about the user vehicle 11 from the attached part information DB 205.

The controller 201 identifies the specific part based on the attachable part information corresponding to the user vehicle 11 and the attached part information about the user vehicle 11 that are acquired based on the user information. The specific part here is a vehicle part attachment of which to the user vehicle 11 is proposed to the user 10. More specifically, the controller 201 identifies, as the specific part, a part, among vehicle parts in the attachable part information corresponding to the user vehicle 11, other than the vehicle parts in the attached part information about the user vehicle 11. Furthermore, the controller 201 transmits, to the user terminal 100, information for proposing attachment of the specific part to the user 10 (hereinafter sometimes referred to as “proposal information”).

(Proposal Process)

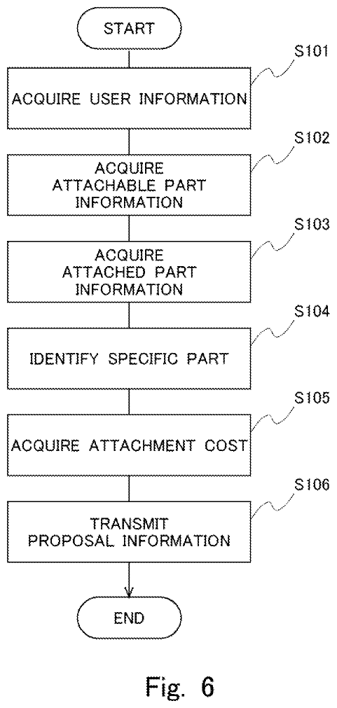

Next, a proposal process that is performed by the controller 201 of the proposal server 200 in the proposal system 1 will be described with reference to FIG. 6. FIG. 6 is a flowchart of the proposal process according to the present embodiment. The proposal process is a process of proposing attachment of the specific part to the user vehicle 11. The proposal process is started when the proposal server 200 receives the user information from the user terminal 100.

In the proposal process, first, the user information is acquired in S101. Next, in S102, the attachable part information corresponding to the user vehicle 11 is acquired based on the user information. Furthermore, in S103, the attached part information about the user vehicle 11 is acquired based on the user information. Next, in S104, the specific part is identified based on the attachable part information corresponding to the user vehicle 11 and the attached part information about the user vehicle 11.

Next, in S105, the attachment cost of the specific part is acquired from the attachable part information stored in the attachable part information DB 204. Then, in S106, the proposal information is transmitted. Here, the proposal information includes information about the attachment cost of the specific part, together with information for proposing attachment of the specific part to the user 10. The user 10 may thereby grasp the necessary cost for attaching the specific part. The proposal process is then ended.

As described above, with the proposal system 1 according to the present embodiment, the specific part is identified based on the user information. Furthermore, with the proposal system 1, the proposal information is transmitted to the user terminal 100. The user 10 thinking about attaching a vehicle part to the user vehicle 11 may thereby be appropriately informed about attachment of the vehicle part.

Additionally, the controller 201 identifies, as the specific part, a part, among vehicle parts in the attachable part information corresponding to the user vehicle 11, other than the vehicle parts in the attached part information about the user vehicle 11. Here, in the case where there is a plurality of specific parts, the controller 201 transmits, to the user terminal 100, the proposal information proposing attachment of the plurality of specific parts. Furthermore, the proposal information at this time includes information about the attachment costs of the plurality of specific parts.

Furthermore, in the present embodiment, the proposal server 200 receives, as the user information, information including the frame number of the user vehicle 11, from the user terminal 100. Here, the user information may be information including the vehicle type, the grade, the manufacturing period, and the color of the user vehicle 11, for example. In this case, the proposal server 200 acquires the vehicle type, the grade, the manufacturing period, and the color of the user vehicle 11 based on the user information. Then, the proposal server 200 acquires information (the attachable part information corresponding to the user vehicle 11) about the vehicle part corresponding to the vehicle type, the grade, the manufacturing period, and the color matching the vehicle type, the grade, the manufacturing period, and the color of the user vehicle 11.

Furthermore, the user information does not necessarily have to be information including the vehicle type, the grade, the manufacturing period, and the color of the user vehicle 11. The user information may be information including the vehicle type of the user vehicle 11. In this case, the proposal server 200 acquires information about the vehicle part for the vehicle type of the user vehicle 11 (the attachable part information corresponding to the user vehicle 11).

### Second Embodiment

There may be a case where there is set, in relation to vehicle parts to be attached to the user vehicle 11, a part that a person other than the manufacturer or the dealer is not allowed to attach (hereinafter sometimes referred to as “predetermined vehicle part”). For example, the predetermined vehicle part is a vehicle part that will void a manufacturer's warranty when the vehicle part is attached to the user vehicle 11 by the user 10. In the case where the user 10 attaches the predetermined vehicle part to the user vehicle 11, the part itself may not be appropriate, or the manner of attachment of the part may not be appropriate, for example. Accordingly, in a present embodiment, in the proposal process, the proposal server 200 determines whether the predetermined vehicle part is attached to the user vehicle 11 by the user 10. In the following, differences from the first embodiment will be described.

(Proposal Process)

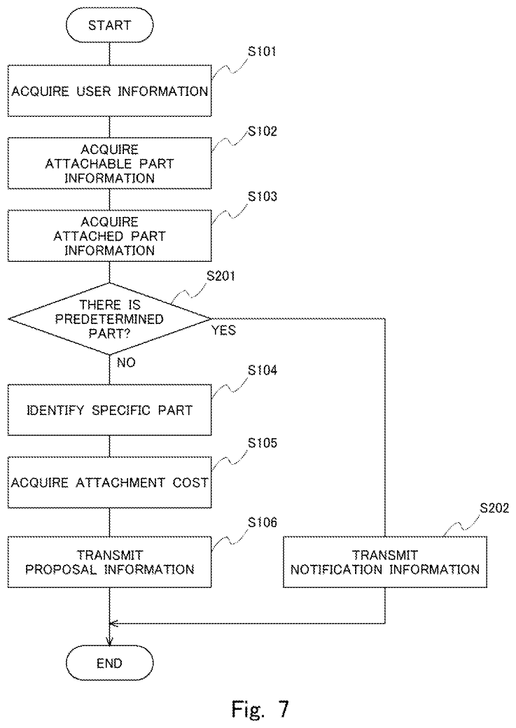

The proposal process that is performed by the controller 201 of the proposal server 200 in the proposal system 1 will be described with reference to FIG. 7. FIG. 7 is a flowchart of the proposal process according to the present embodiment. Additionally, processes from S101 to S106 illustrated in FIG. 7 are the same as the processes from S101 to S106 illustrated in FIG. 6, and description thereof will be omitted.

After the attached part information is acquired in S103, whether vehicle parts attached by the user 10, among the vehicle parts that are currently attached to the user vehicle 11, include the predetermined vehicle part or not is determined in S201. Additionally, information about the predetermined vehicle part regarding the user vehicle 11 may be stored in advance in the proposal server 200. Furthermore, the proposal server 200 may receive information about the predetermined vehicle part regarding the user vehicle 11 from a server apparatus of the manufacturer or the dealer of the user vehicle 11 through the network N1. In the case where a negative determination is made in S201, the processes from S104 to S106 are performed, and the proposal process is ended.

In the case where a positive determination is made in S201, the controller 201 may grasp that the user vehicle 11 is a vehicle to which the predetermined vehicle part is attached by the user 10. Accordingly, the proposal information is not transmitted, and notification information is transmitted to the user terminal 100 in S202. The notification information here is information for notifying that a new vehicle part cannot be attached to the user vehicle 11 because the predetermined vehicle part is attached by the user 10. In this manner, in the case where the positive determination is made in S201, transmission of the proposal information is not performed. The proposal process is then ended.

As described above, in the present embodiment, in the case where the predetermined vehicle part is attached to the user vehicle 11 by the user 10, the notification information is transmitted. That is, a notification indicating that a new vehicle part cannot be attached to the user vehicle 11 is issued by the proposal system 1. Also in this case, the user 10 thinking about attaching a vehicle part to the user vehicle 11 may be appropriately informed about attachment of the vehicle part.

### Third Embodiment

In a present embodiment, the proposal server 200 issues an incentive to the user 10 in a case where a vehicle part which was not sold at the time of purchase of the user vehicle 11 by the user 10 is to be attached to the user vehicle 11. In the following, differences from the first embodiment will be described.

(Proposal Process)

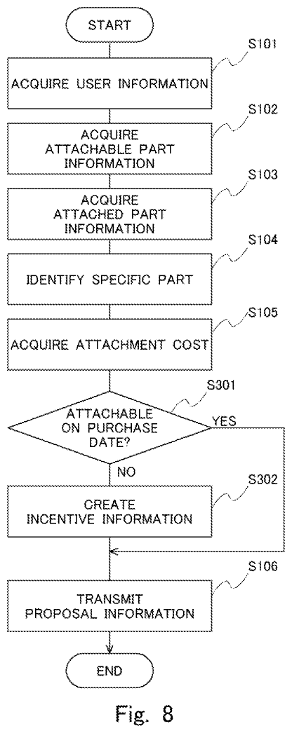

A proposal process that is performed by the controller 201 of the proposal server 200 in the proposal system 1 will be described with reference to FIG. 8. FIG. 8 is a flowchart of the proposal process according to the present embodiment. Additionally, processes from S101 to S106 illustrated in FIG. 8 are the same as the processes from S101 to S106 illustrated in FIG. 6, and description thereof will be omitted.

In the proposal process, after the process in S105, whether the specific part was attachable on the purchase date of the user vehicle 11 of the user 10 is determined. More specifically, the controller 201 acquires the purchase date of the user vehicle 11 by the user 10, from the vehicle information stored in the vehicle information DB 203. Furthermore, the controller 201 acquires the attachable date of the specific part from the attachable part information stored in the attachable part information DB 204. Then, in the case where the purchase date of the user vehicle 11 is later than the attachable date of the specific part, it is determined that the specific part was attachable at the time of purchase of the user vehicle 11 by the user 10. That is, a positive determination is made in S301. In the case where the purchase date of the user vehicle 11 is before the attachable date of the specific part, it is determined that the specific part was not attachable at the time of purchase of the user vehicle 11 by the user 10. That is, a negative determination is made in S301.

In the case where the negative determination is made in S301, information indicating an incentive to be given to the user 10 (hereinafter sometimes referred to as “incentive information”) will be created in S302. The incentive information here is information about a discount on the attachment cost of the specific part, for example. The incentive information may alternatively be a point or the like that can be used for a service other than attachment of the specific part, for example. Next, in S106, the proposal information is transmitted to the user terminal 100. The proposal information here includes the incentive information. In the case where the positive determination is made in S301, the proposal information is transmitted to the user terminal 100 in S106. In this case, the proposal information does not include the incentive information. The proposal process is then ended.

As described above, in the present embodiment, whether the specific part was attachable at the time of purchase of the user vehicle 11 by the user 10 is determined. In the case where the specific part was not attachable at the time of purchase of the user vehicle 11 by the user 10, the incentive information is created for the user 10. The user 10 may thus be encouraged to attach, to the user vehicle 11, a part which was not attachable at the time of purchase of the user vehicle 11. The user 10 thinking about attaching a vehicle part to the user vehicle 11 may thereby be appropriately informed about attachment of the vehicle part which was not attachable at the time of purchase of the user vehicle 11.

### Other Embodiments

The embodiments described above are merely examples, and the present disclosure may be changed as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, and any type of medium suitable for storing electronic instructions, such as optical cards.

What is claimed is:

1. An information processing apparatus comprising a controller, the controller comprising at least one processor being configured to:
acquire, based on first information for identifying a specific vehicle, second information about a vehicle part that is attachable to the specific vehicle, and third information about a vehicle part that is currently attached to the specific vehicle,
identify, based on the second information and the third information, a specific part that is a vehicle part that is to be proposed to be attached to the specific vehicle, and
transmit information about the specific part to a terminal associated with a user of the specific vehicle.

2. The information processing apparatus according to claim 1, wherein the first information is information including an identifier of the specific vehicle.

3. The information processing apparatus according to claim 1, wherein the first information is information including a vehicle type of the specific vehicle set by a manufacturer of the specific vehicle.

4. The information processing apparatus according to claim 3, wherein the first information is information further including at least one of a grade, a manufacturing period, and a color of the specific vehicle.

5. The information processing apparatus according to claim 2, wherein the controller identifies, based on the first information, a vehicle type of the specific vehicle set by a manufacturer of the specific vehicle, and acquires the second information based on the vehicle type of the specific vehicle.

6. The information processing apparatus according to claim 2, wherein the controller identifies, based on the first information, a vehicle type of the specific vehicle set by a manufacturer of the specific vehicle and at least one of a grade, a manufacturing period, and a color of the specific vehicle, and acquires the second information based on the vehicle type of the specific vehicle set by the manufacturer of the specific vehicle and the at least one of the grade, the manufacturing period, and the color of the specific vehicle.

7. The information processing apparatus according to claim 1, wherein the controller acquires a cost necessary at a time of attaching the specific part to the specific vehicle, and transmits information including the cost to the terminal associated with the user.

8. The information processing apparatus according to claim 1, wherein the third information is information including information about a vehicle part attached by a person other than a manufacturer or a dealer of the specific vehicle.

9. The information processing apparatus according to claim 8, wherein
the controller is further configured to perform a determination process of determining, based on the third information, whether a predetermined vehicle part that is not allowed to be attached by a person other than the manufacturer or the dealer of the specific vehicle is included in the vehicle part attached by the person other than the manufacturer or the dealer of the specific vehicle, and
the controller does not transmit information about the specific part to the terminal associated with the user of the specific vehicle, in a case where a positive determination is made in the determination process.

10. The information processing apparatus according to claim 1, wherein the controller is further configured to create information indicating an incentive to be given to the user in a case where the specific part that was not attachable at a time of purchase of the specific vehicle by the user is to be attached to the specific vehicle.

11. An information processing method performed by a computer, the information processing method comprising:
acquiring, based on first information for identifying a specific vehicle, second information about a vehicle part that is attachable to the specific vehicle, and third information about a vehicle part that is currently attached to the specific vehicle;
identifying, based on the second information and the third information, a specific part that is a vehicle part that is to be proposed to be attached to the specific vehicle; and
transmitting information about the specific part to a terminal associated with a user of the specific vehicle.

12. The information processing method according to claim 11, wherein the first information is information including an identifier of the specific vehicle.

13. The information processing method according to claim 11, wherein the first information is information including a vehicle type of the specific vehicle set by a manufacturer of the specific vehicle.

14. The information processing method according to claim 13, wherein the first information is information further including at least one of a grade, a manufacturing period, and a color of the specific vehicle.

15. The information processing method according to claim 12, wherein a vehicle type of the specific vehicle set by a manufacturer of the specific vehicle is identified based on the first information, and the second information is acquired based on the vehicle type of the specific vehicle.

16. The information processing method according to claim 12, wherein a vehicle type of the specific vehicle set by a manufacturer of the specific vehicle and at least one of a grade, a manufacturing period, and a color of the specific vehicle are identified based on the first information, and the second information is acquired based on the vehicle type of the specific vehicle set by the manufacturer of the specific vehicle and the at least one of the grade, the manufacturing period, and the color of the specific vehicle.

17. The information processing method according to claim 11, wherein a cost necessary at a time of attaching the specific part to the specific vehicle is acquired, and information including the cost is transmitted to the terminal associated with the user.

18. The information processing method according to claim 11, wherein the third information is information including information about a vehicle part attached by a person other than a manufacturer or a dealer of the specific vehicle.

19. The information processing method according to claim 18, further comprising a determination process of determining, based on the third information, whether a predetermined vehicle part that is not allowed to be attached by a person other than the manufacturer or the dealer of the specific vehicle is included in the vehicle part attached by the person other than the manufacturer or the dealer of the specific vehicle, wherein
information about the specific part is not transmitted to the terminal associated with the user of the specific vehicle, in a case where a positive determination is made in the determination process.

20. A non-transitory storage medium storing a program for causing a computer to execute an information processing method, wherein the information processing method includes:
acquiring, based on first information for identifying a specific vehicle, second information about a vehicle part that is attachable to the specific vehicle, and third information about a vehicle part that is currently attached to the specific vehicle,
identifying, based on the second information and the third information, a specific part that is a vehicle part that is to be proposed to be attached to the specific vehicle, and
transmitting information about the specific part to a terminal associated with a user of the specific vehicle.
